(19) United States
(12) Patent Application Publication
(10) Pub. No.: US 2009/0057096 A1
(43) Pub. Date: Mar. 5, 2009

(54) Front Panels for Vending Machines

(76) Inventors: Larry Hieb, Fresno, CA (US); Daniel Carter, Fresno, CA (US)

Correspondence Address: MARK D MILLER;KIMBLE, MACMICHAEL & UPTON, 5260 NORTH PALM AVENUE, SUITE 221, FRESNO, CA, 93704, US

(21) Appl. No.: 12/196,126

(22) Filed: Aug. 21, 2008

Related U.S. Application Data
(60) Provisional application No. 60/967,015, filed on Aug. 30, 2007.

(51) Int. Cl. G07F 9/10

(52) U.S. Cl. 194/350

(57) ABSTRACT

The present invention provides methods and apparatus for reducing or preventing sunlight from reaching the interior of a vending machine through its front panel, and also providing for the placement of advertising, information, and/or identification of the products inside the machine. Embodiments of the invention include an obscuring peripheral border provided around a viewing area of the front panel of a vending machine. Other embodiments include methods and apparatus for scrolling specialized film behind the front panel of a vending machine.

This application claims the benefit of U.S. Provisional Application Ser. No. 60/967,015 filed on Aug. 30, 2007 which is incorporated herein by this reference.

### BACKGROUND OF THE INVENTION

1. Field of the Invention

The present invention relates to vending machines and their methods of operation, and more particularly to devices and methods used in conjunction with the front panels of vending machines to help control the internal temperature of the vending machines particularly when deployed outdoors.

2. Description of the Prior Art

A wide variety of different products are provided to consumers through vending machines. Many of these products (such as ice cream or milk) require refrigeration to maintain freshness; other products (such as carbonated soda or beer) are preferably dispensed in a refrigerated condition for consumer convenience; still other products (such as chocolate or candy bars) should not be subjected to excessively warm temperatures to avoid degenerating or melting. Conversely, other kinds of products (such as coffee or hot chocolate) are generally dispensed at elevated temperatures. It is well known that the external environment surrounding a vending machine will have a direct effect on the internal temperature of the vending machine itself. As a result, vending machines are frequently provided with internal heating and/or cooling devices as well as insulated cabinets.

In the vending machine industry, it is important that each vending machine have an appearance that is attractive and appealing to potential consumers. Since vending machines are typically placed in confined spaces or side-by-side in rows, users ordinarily encounter only the front panels of the vending machines. As a result, the front panel of a vending machine is often the most important panel from a user standpoint. Not only does the front panel provide the user interface for payment and dispensing of products, it is also provides advertising and/or identification of the products contained inside. In many cases, it is desirable for the user to be able to see the products inside the vending machine through the front panel. As a result, it is typical for vending machine front panels to be provided in the form of transparent glass, plastic, or other similar material. Unfortunately, providing transparent front panels on vending machines makes it more difficult to maintain an appropriate temperature inside the machine itself.

For vending machines placed in outdoor environments, the front panel will be directly exposed to wide temperature variations, and may also be directly exposed to sunlight. These factors will have a significant impact on the internal temperature of the machine. Exposure to direct sunlight is particularly troublesome since the sunlight (including heat, radiation, ultraviolet rays, infrared rays, etc.) may penetrate through the transparent front panel and heat up internal surfaces of the vending machine, including the products themselves. An outdoor vending machine whose front panel is exposed to direct sunlight on a hot summer day may have great difficulty maintaining an appropriately cool internal temperature for the products it contains. Similarly, an outdoor vending machine that is deployed in the shade on a cold winter day may have difficulty maintaining a warm internal temperature for its products.

An indoor environment would ordinarily be expected to be less harsh for a vending machine than an outdoor environment, but even indoor vending machines may be subjected to stress from their environments. For example, indoor vending machines are frequently placed near windows or doors where they are exposed to direct sunlight, or the indoor climate control may be shut off at night and over weekends allowing temperatures to climb or drop dramatically, etc. If a vending machine cannot maintain an appropriate internal temperature, the products inside it may be rendered undesirable or they may spoil, neither of which is acceptable to vendors or consumers.

It is therefore desirable to provide front panels and related devices and methods for vending machines that help the vending machine to maintain a desired internal temperature while also providing advertising and/or identification of the products contained inside the machine.

### SUMMARY OF THE INVENTION

Embodiments of the present invention provide front panels and related devices and methods for preventing the interior of a vending machine from being exposed to direct sunlight through the front panel. Embodiments of the present invention also provide front panels and related devices and methods for advertising and/or identification of products contained inside a vending machine.

In some embodiments of the present invention, the front panel or door of a vending machine is provided with a vandal-resistant outer panel having a viewing area in the center and a peripheral border surrounding the central viewing area. The viewing area is preferably clear, transparent or semi-transparent so that a user may see through it into the interior of the vending machine. The border is not necessarily transparent, and is designed to limit or prevent some direct sunlight from entering the internal product storage area of the vending machine. The border may have a plain appearance, or it may be provided with any suitable printed or graphic material. This material may include product branding, advertising, trademarks, instructions, or other suitable content. The border may be of any suitable width, it being appreciated that the thicker the border, the more sunlight that may be blocked. However, it is also desirable for the user to be able to see into the vending machine through the central viewing area in the front panel, for example, to be able to see the fronts of the product queues inside the vending machine. It is therefore preferred that the border have a width such that if a consumer approaches the machine, the consumer is able to see most or all of the product fronts from a reasonable distance (e.g. from within an arm's length or two of the machine). It is to be appreciated that a wider border would require a consumer to approach the machine more closely to see all of the product fronts—but this may be necessary for machines deployed in areas of very bright sunlight. In some embodiments, the border as well as the central viewing area surrounded by a border may be made of materials or may include coatings, mirrored or reflective surfaces to help prevent or reduce sunlight from passing through.

In other embodiments, a separate interior panel may be provided behind the front panel of the vending machine, between the front panel and the products inside the machine, and obscuring borders may be provided on one or both panels surrounding central viewing areas thereon.

In other aspects and embodiments of the invention, a front panel or door of a vending machine (with or without a border) may be provided with a mechanism that scrolls a film inside the machine behind a viewing area of the front panel. This film may be mounted on spools inside the machine that may be located on both sides of the front panel, at the top and bottom of the front panel, or elsewhere. In some embodiments, the front panel may include a screen or border in the vicinity of the spools to hide the spools themselves from view, and/or to prevent sunlight from entering the machine as described above. The film should be mounted such that it may be scrolled from one spool to the other inside the machine, stretching across and behind the front panel during the process. In some embodiments, a guide may be provided directly behind the front panel over which the film travels in order to keep the film close to the front panel so that text, graphics and other information on the film may be easily viewed and read. In some embodiments, the guide may be contoured to correspond with or parallel any similar contours of the front panel. In some embodiments, lighting (e.g., one or more elongated fluorescent bulbs) may also be provided to illuminate the film between the spools so that it may be seen through the viewing area of the front panel. Such lighting may be provided at any suitable location including without limitation, adjacent to one or both of the spools, on one or both sides of the film, above and/or below the film.

In preferred embodiments, the film should include at least one panel having viewing area that is preferably clear, transparent or semi-transparent such that when this section is scrolled into place behind the front panel of the vending machine, a customer is able to look through viewing areas in the front panel and the film in order to view the interior of the vending machine and available products inside. One or more other panels or sections of the film may be fully or partially non-transparent, obscuring the view into the vending machine in order to prevent or reduce the amount of sunlight that may penetrate into the machine while such sections are in place. Such obscuring sections may simply be blank (e.g. opaque), or they may contain one or more graphic images, advertising, trademarks, instructions, or other suitable content. It is to be appreciated that the purpose of such obscuring film sections is to prevent or reduce the amount of sunlight that may penetrate into the machine while such sections are in place. In this regard, both the viewing sections and the obscuring sections of the film may be made of materials or may include coatings, mirrored or reflective surfaces to help prevent or reduce sunlight from passing through them.

In some embodiments, an obscuring section of film may be scrolled into place behind the vending machine front panel and left there indefinitely until a customer is detected, as described below, whereupon another panel is moved into place. This other panel may be a viewing section that is fully or partially transparent, and/or may include instructions, information or advertising. In other embodiments, different panels may be scrolled behind the front panel for time intervals, as described more fully below, and this scrolling may be interrupted when the presence of a customer is detected. In other embodiments, the scrolling of film panels is not interrupted.

In some embodiments, sensors may be provided in association with the vending machine to detect when a customer approaches or makes contact with the machine. These sensors may be in any suitable form including without limitation one or more motion sensors, sound sensors, light sensors, temperature sensors, pressure sensors, etc. By way of example and without limitation, one or more motion sensors may detect the presence of a potential customer through movement in the vicinity of the machine; one or more sound sensors may pick up sounds made by a potential customer in the vicinity of the machine; one or more light sensors may be triggered by a potential customer interrupting a light beam in the vicinity of the machine; one or more temperature sensors may detect an elevated or reduced temperature created by a potential customer in the vicinity of the machine; one or more pressure sensors may be provided in or on the floor or a mat in front of the machine that are triggered by the weight of a potential customer. Other sensors associated with the operation of the machine may also be triggered when, for example, the user touches the machine, money is deposited into the machine, a product selection is made, etc.

In some embodiments, when the presence of a potential customer is detected by one or more sensors associated with the machine, this may trigger the scrolling mechanism to cause a viewing section of film to be moved behind the front panel, allowing the customer to see into the machine in order to view the products inside. This viewing section may be kept in place behind the front panel for a set period of time, or for as long as a sensor detects the presence of the user and may then be moved away, or it may stay in place afterwards for a timeout (e.g. 1-5 min.) after the user is no longer detected. At the end of such period, an obscuring film section may then be scrolled into place, and/or a scrolling sequence resumed, etc.

In some embodiments, a two-part process may be initiated when the presence of a user is detected. In the first step, when a user triggers a sensor, this causes a particular obscuring section of the film to be moved behind the front panel. Such a section may display specific advertising or information relating to the products inside the machine, instructions, or other appropriate content. In a second step, the user may then cause a viewing section of film to be scrolled into place by following displayed instructions, touching the machine, inserting coins or currency into the machine, or other subsequent triggering actions.

In other aspects of the scrolling film embodiments, multiple obscuring sections may be provided on the film containing such things as advertising, trademarks, information, etc. In some default modes, these sections may be scrolled into place behind the front panel in a pre-determined sequence for pre-determined time periods, which may or may not be of the same length, thereby preventing sunlight from penetrating into the machine, while also providing changing advertising or other content across the front of the vending machine. The time periods of display may be the same or different lengths, and advertisers may be charged differently according to the length of time their advertising is displayed. In some embodiments, these sections may be displayed in a pre-determined order; in other embodiments, these sections may be displayed in a random or semi-random order.

By way of example and without limitation, a given scroll of film may include twelve (12) sections, eleven (11) of which are obscuring, and one (1) of which is for viewing. The one exemplary viewing section may be designed to be scrolled into place when, for example, a user is detected by a sensor of the machine. The other eleven exemplary sections are scrolled behind the front panel in a pre-determined, random or other manner until interrupted by a user. In this example, each such obscuring section may be scrolled into place for a time interval such as, for example, one minute, in which case the unit would cycle through the entire sequence of obscuring sections in eleven minutes, and then start over. The viewing section may or may not also be scrolled into place for a time interval, depending on whether it is more desirable for a customer to catch a glimpse of the content of the machine, or for sunlight to be blocked. It is to be appreciated that, as described previously, different sections may be scrolled into place for the same or different time intervals.

In the scrolling film embodiments, the film sections need not necessarily be displayed in the order that they are provided on the film, although this may be preferred in order to avoid excessive wear on the film through additional scrolling. In some embodiments, the film sections may be displayed sequentially as they appear on the film, and the viewing sections may or may not be skipped. In some embodiments, when the end of the scroll is reached, it may be rewound after which the film sections may again be displayed in the same sequence. In other embodiments, when the end of the scroll is reached, the film may simply reverse direction and display the film sections in a reversed sequence. In alternative embodiments, different display times may be attributed to different sections. It is preferred that the viewing section(s) not be included in the display sequence (or that they be skipped), in order to avoid unnecessary direct exposure of the interior of the machine to sunlight. However, in some embodiments it may be desirable to include the viewing section(s) in the sequence to reveal the contents of the vending machine in order to attract potential customers. In embodiments where large numbers of obscuring sections are used, more than one viewing section may be included to make it easier to quickly spool to such a section, if desired, upon the detection of a user.

It is to be appreciated that an obscuring border as described previously may also be provided on the viewing section(s) of the film. An obscuring border may also be provided on the front panel or door that is associated with a scrolling film embodiment, thereby maintaining some level of protection from sunlight even when a viewing section of film is scrolled into place.

It is to be appreciated that the devices of the present invention may be used with a wide variety of different front door and front panel configurations, and that one or more of the different embodiments disclosed herein may be used together with one or more of the other embodiments to provide additional environmental protection for the vending machine.

It is therefore an object of embodiments of the present invention to provide front panels and related devices and methods for vending machines for minimizing the exposure of the interior of vending machines to direct sunlight through the front panel.

It is also an object of embodiments of the present invention to provide front panels and related devices and methods for vending machines for providing advertising, information and/or identification of products contained inside such vending machines.

### BRIEF DESCRIPTION OF THE DRAWINGS

FIG. 1 is a perspective view of a vending machine illustrating an embodiment of the present invention.

FIG. 2 is a perspective view of a vending machine illustrating an embodiment of the present invention.

FIG. 3 is a front view of a vending machine illustrating alternative embodiments of the present invention.

FIG. 4 is a side view of a vending machine illustrating alternative embodiments of the present invention.

FIG. 5 is a top sectional view of a vending machine illustrating an alternative embodiment of the present invention.

FIG. 6 is a top sectional view of a vending machine illustrating an alternative embodiment of the present invention.

FIG. 7 is a top sectional view of a vending machine illustrating an alternative embodiment of the present invention.

FIG. 8 is a detailed view of an embodiment of a scrolling apparatus used in some embodiments of the invention.

FIG. 9 is an enlarged detail view of a optical device used in some embodiments of the invention.

### DETAILED DESCRIPTION

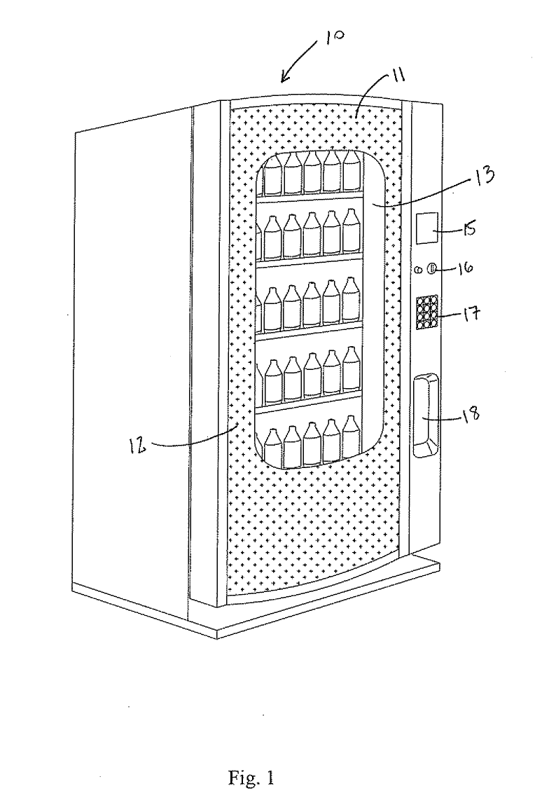

Referring to the drawings wherein the same reference numeral may be used to designate different parts throughout the several views, and referring particularly to the illustrated exemplary embodiment of FIG. 1, it is seen that a vending machine 10 is provided having an outer front panel 11 that is typically but not necessarily part of the front door of the machine. In the embodiment illustrated in FIG. 1, an obscuring border 12 is provided around the edges or periphery of a central viewing area 13 of panel 11. Border 12 prevents sunlight from penetrating directly into the internal product storage area of the machine. The thickness of border 12 may be varied depending on the amount of sunlight blockage sought, it being understood that the wider the border the closer a user must approach the machine in order to have a good view of the products inside, particularly those near the edges. It is to be appreciated that the amount of sunlight blocked may vary depending on whether the border is truly opaque, what colors and/or graphics are used in the border, whether there are breaks or openings in the graphics, and other similar factors. The viewing area 13, as well as any transparent or non-transparent portions of the border 12 may be treated or surfaced with materials or coatings to block or diminish the amount of sunlight that may penetrate through them.

For example and without limitation, a wide peripheral border of between 8 and 12 inches will prevent a significant amount of sunlight from entering the machine through the front panel; however, such a border will require a user to come very close to the machine in order to see the fronts of all product queues in the machine. In another example, a border of between 4 and 6 inches will prevent a lesser amount of sunlight from entering the machine through the front panel; but, such a border will not require a user to come as close to the machine in order to see the fronts of all product queues in the machine. The viewing area is preferably centered on the products in the machine such that a wide border may be provided at the bottom (or top), as illustrated in FIG. 1.

In some embodiments, a second and separate panel may be provided behind the front panel. In these embodiments, a border may be placed on either the front panel or the second panel, or both. It is to be appreciated that the bordered embodiments may be combined with one or more other embodiments disclosed herein to provide additional protection from sunlight.

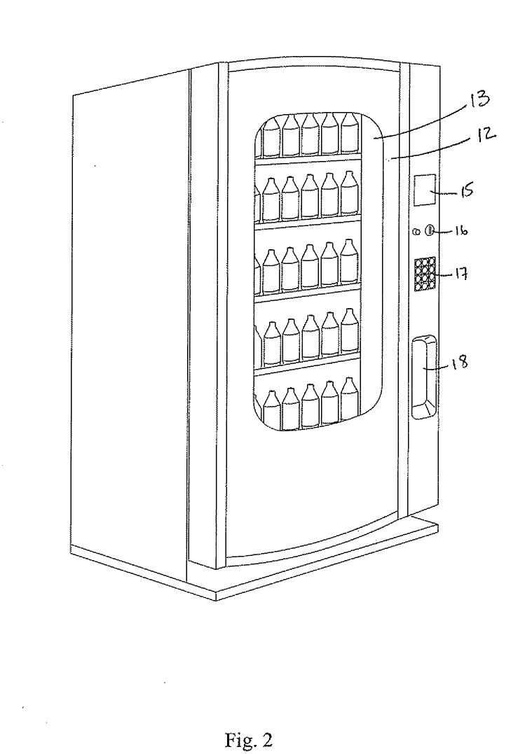

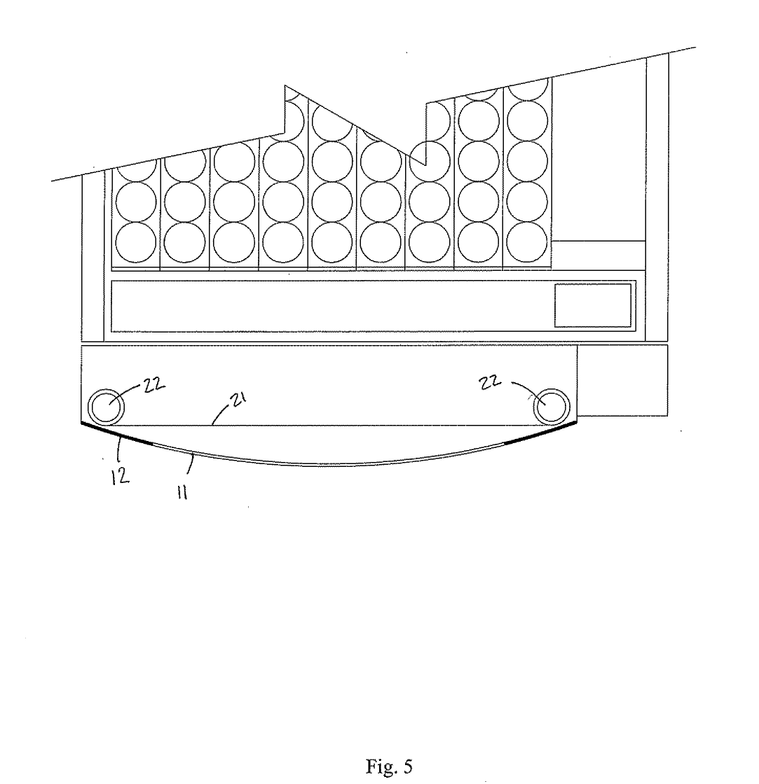

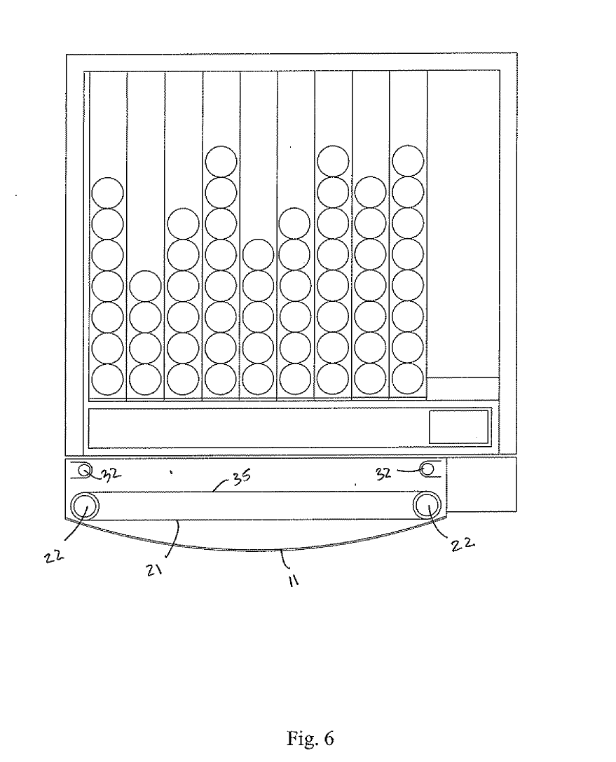

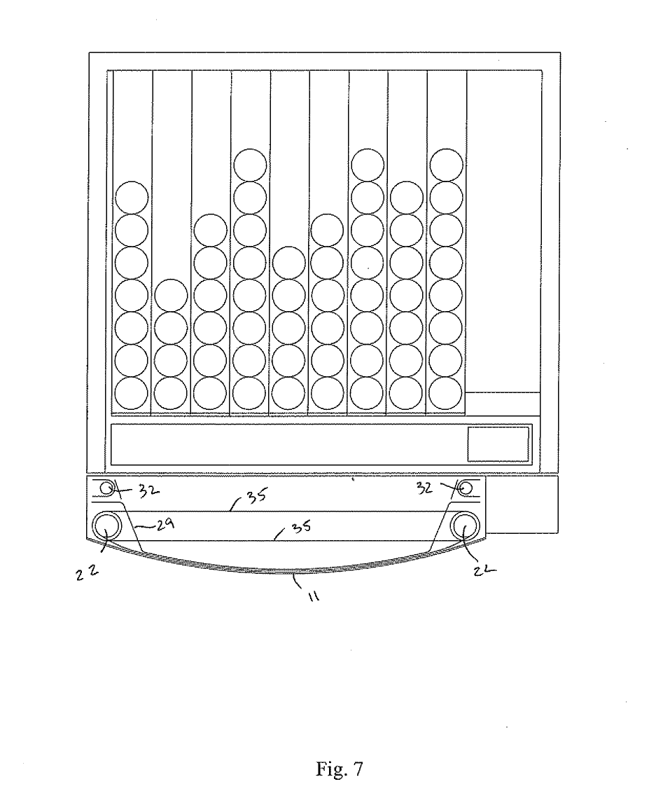

In alternative embodiments, such as those illustrated in FIGS. 5-7, a film 21 is mounted on rotatable scrolls 22 inside the vending machine behind the door or front panel 11. Portions of this film have obscuring material thereon to prevent or limit the amount of sunlight that may enter the machine through the front panel. An exemplary illustration of such an embodiment is found in FIG. 5. This illustration shows a top view with the scrolls 22 behind a front panel on either side; however, it is to be appreciated that the scrolls 22 may alternatively be provided at the top and bottom of the front panel 1, or at other suitable locations. In some embodiments, such as those illustrated in FIGS. 1 and 2, the front panel may be provided with an obscuring border area 12 which may be used to hide the scrolls 22. Lighting 32 may also be provided to illuminate the film between the scrolls and may be mounted at any suitable location, which may be adjacent to one or both of the scrolls as shown in FIGS. 6 and 7.

In some embodiments, such as those illustrated in FIGS. 5 and 6, it is seen that the film 21 is stretched directly between scrolls 22 such that film 21 is slightly separated from front panel 11, especially if front panel 11 has a bowed or arcuate shape. In other embodiments, such as that illustrated in FIG. 7, one or more guides 29 may be provided for holding the film close to front panel 11. In these embodiments, guide 29 is preferably clear or transparent so that it does not interrupt viewing of the interior. In some embodiments, guide 29 may be a large viewing panel provided with its own sunlight blocking border 12, and may also be treated or coated with sunlight or heat reflecting materials. In other embodiments, upper and lower guides 29 in the form of troughs for receiving the edges of the film 21 may be provided. Film 21 is scrolled across or along guide(s) 29 in close proximity to the inside of front panel 11 so that advertising, instructions or other information depicted on film 21 may be more easily seen and read by users without potential distortion from a bowed or arcuate shape of front panel 11.

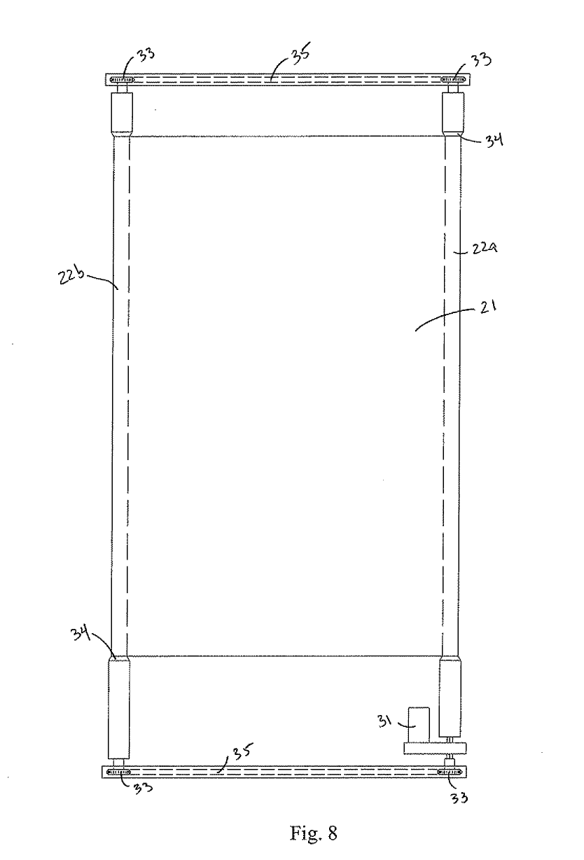

In the scrolling embodiments, each scroll 22 is rotatable, and each scroll is operated directly or indirectly by a motor 31 that is capable of rotating the scroll in either direction (clockwise or counter-clockwise). In some embodiments, a single motor 31 may be employed to move both scrolls as shown in the exemplary embodiment of FIG. 8. In these embodiments, a first scroll 22a is operated directly by motor 31; and the other scroll 22b is operated indirectly through a belt, chain, or other motion transmitting structure 35. For example and without limitation, each scroll may be provided with at least one sprocket 33 at one end, and a continuous chain or belt 35 is engaged around both of these sprockets 33 so that they rotate in unison when powered by the single motor 31. In the exemplary embodiment illustrated in FIG. 8, sprockets 33 are provided at both the upper and lower ends of scrolls 22a and 22b, and upper and lower chains 35 are provided between the upper and lower sprocket pairs. In other embodiments, such synchronization structures may be provided only at the tops or only at the bottoms of the scrolls. In some embodiments, as illustrated in FIG. 8, annular shoulders 34 or other similar guides may be provided on one or both scrolls 22 to center the film thereon. In alternative embodiments, separate motors 31 may be provided for each scroll 22.

Programming or other electronics may be provided to rotate the scrolls so that selected sections of the film 21 are moved into place behind front panel 11 where they may be seen through the viewing portion of front panel 11. In some embodiments, encoding or tracking devices (not shown) may be associated with the motor(s) 31, with belts 35, or with the film itself 21 in order to assist a processor in keeping track of the locations of various sections of the film. These encoders may track such things as rotations of the motor, links or distances on a chain or belt, notches/openings on the film, etc. This makes it possible to determine where a desired section of film is located if it is to be rotated into place behind the front panel in response to a triggering event. Such an event may be a signal from one or more sensors (e.g. motion, light, sound, temperature, pressure, etc.).

In the scrolling film embodiments, film 21 is preferably provided with at least one viewing section that may be completely or partially (e.g. bordered) transparent, allowing the user to see into the vending machine when this section is scrolled behind the front panel. Other sections of film 21 may be partially or completely obscuring. It is to be appreciated that the amount of sunlight blocked by the obscuring sections may vary depending on whether these sections are truly opaque, what colors and/or graphics are used in these sections, whether there are breaks or openings in the graphics, and other similar factors. The viewing sections of film 21, as well as any transparent portions of non-transparent sections, and/or any obscuring sections of film 21 may be treated or surfaced with materials or coatings to block or diminish the amount of sunlight that may penetrate through them.

In some of these embodiments, a single obscuring section of the film 21 may be scrolled into place behind front panel 11 to block sunlight in a default condition. Alternatively, a number of obscuring (and/or viewing) sections of the film may be temporarily scrolled into place behind the front panel for time intervals (which may be the same or of different lengths) in a pre-determined, random or other order as part of a default sequence. The default condition or sequence may be interrupted by a triggering event caused by activation of a sensor by a user as described elsewhere herein. Such an event may cause a viewing or other identified section of film to be scrolled into place behind the front panel. In some embodiments, a second or further triggering event may be required in order to cause a viewing section of film to be scrolled into place.

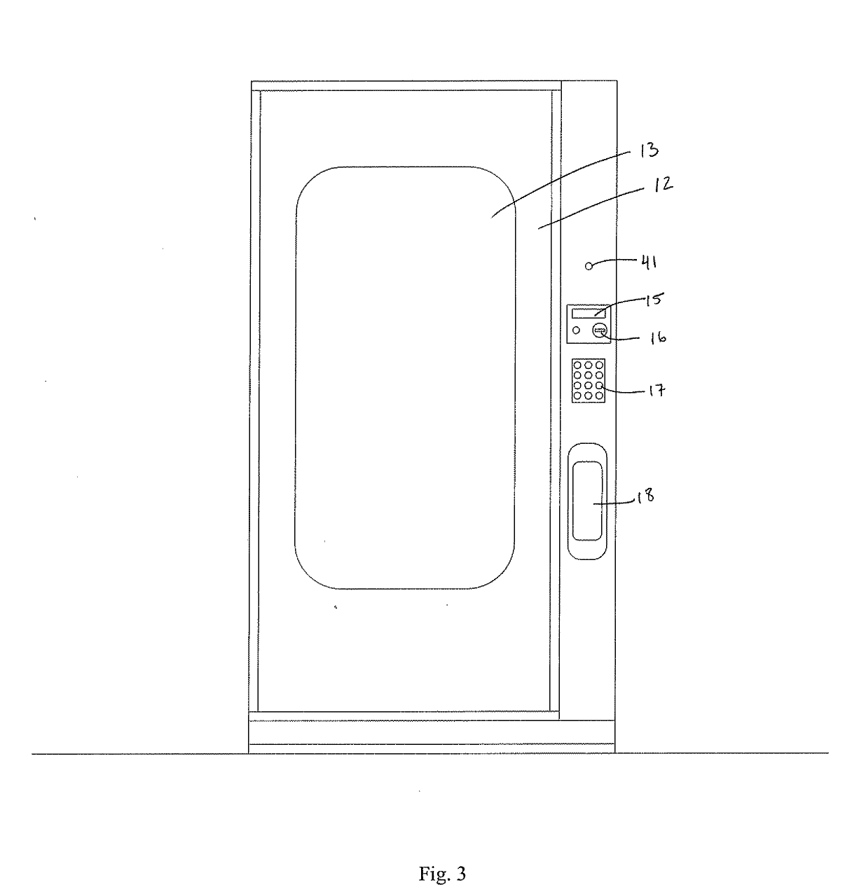

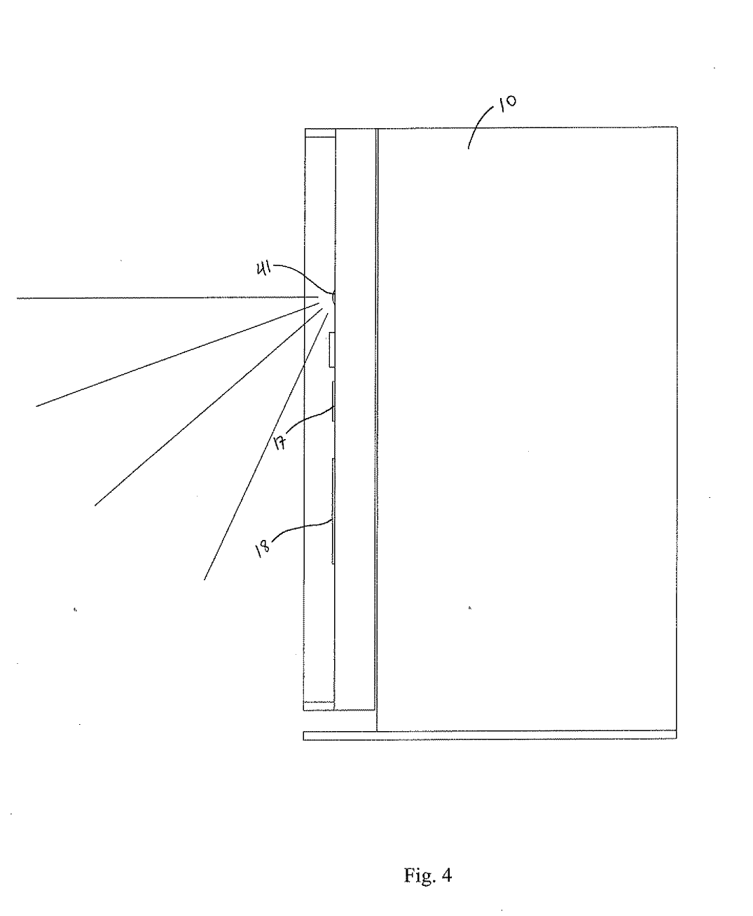

By way of example, and without limitation, a user may cause a triggering event if one or more motion sensors 41 detect the presence of a potential customer through movement in the vicinity of the machine (see, e.g., FIGS. 3 and 4); one or more sound sensors (not shown) may pick up sounds made by a potential customer in the vicinity of the machine; one or more light sensors (not shown) may be triggered by a potential customer interrupting a light beam in the vicinity of the machine; one or more temperature sensors (not shown) may detect an elevated or reduced temperature created by a potential customer in the vicinity of the machine; one or more pressure sensors (not shown) may be provided in or on the floor or a mat in front of the machine that are triggered by the weight of a potential customer. Alternatively, or in addition, an initial or further triggering event may occur through a user touching or using any of the components on the front panel of the machine such as the coin insert 16, keypad or product selection device 17, bill insert 15, coin return 14, and/or delivery port 18. For example, in some embodiments, when the presence of a user is first detected by a first sensor, the processor may cause a motor to scroll a section of film behind the front panel which includes written instructions such as “touch any control to see inside.” If the user then touches a part of the machine (e.g. the coin insert, keypad, product selection device, bill insert, delivery port) a second sensor detects this, and the processor may then cause a viewing section of film to then be scrolled behind the front panel. In this way, an uninterested passerby may not cause the machine to unnecessarily expose the internal contents to sunlight.

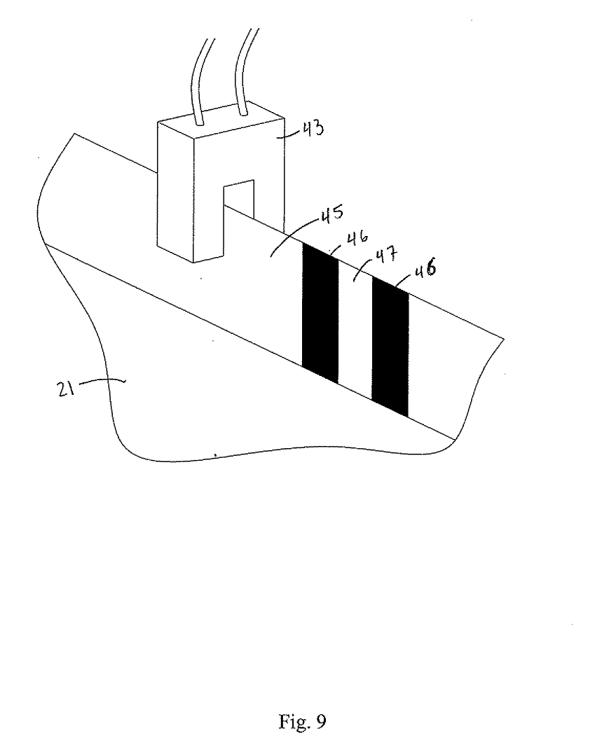

In some embodiments, film 21 may be provided with a thin border along one or both edges (upper or lower), and a light sensitive device 43 may be used to monitor this border, as shown in an exemplary embodiment in FIG. 9. In these embodiments, the edge border 45 may have light sensitive and/or reflective properties that may be provided in patterns that are recognized by a processor in communication with the light sensitive device 43. The light sensitive device 43 is capable of identifying the light sensitive properties of the edge border 45 and distinguishing, for example, between the opaque 46 and transparent 47 portions of the edge border 45, and may provide a signal to the processor indicating which type of edge border is currently scrolled into place. For example, and without limitation, edge border 45 may be opaque 46 in areas along the edges of the obscuring sections of film, but transparent 47 along the edge(s) of any viewing sections of film. In some embodiments, a pattern of light sensitive properties may be provided on one or both the edge borders. By way of example and without limitation, such a pattern could include a recognizable pattern at the beginning or end of each film section in order to identify a transition from one section of film to the next. An example of such a pattern is illustrated in FIG. 9. It is to be appreciated that in alternative embodiments, other patterns or light sensitive properties may be used, for example, the opaque borders may be associated with the viewing film section(s), and that the transparent borders may be associated with the obscuring film section(s). An encoder is generally not required in these embodiments.

In use, an exemplary embodiment may operate as follows: a user may approach or touch the vending machine which is detected by one of the sensors. This causes a signal to be sent to a processor, which interrupts a sequence of film sections being scrolled behind front panel 11. The processor may stop the scrolling of film 21, or it may cause motor(s) 31 to start scrolling film 21 toward a particular section. The processor tracks signals received from an encoder or from a light sensitive device 43 to determine what sections of film 21 are passing by during the scrolling process. Once a desired section of film is known to be in place behind front panel 11, the processor may stop the motor 31. In most embodiments, this will be a viewing section of film. However, in some embodiments, a non-viewing film section has been moved into place, and the processor may await another signal from a sensor before activating motor(s) 31 a second time to move a viewing panel into place. The user may or may not then cause a vending operation to take place. If the presence of a user is no longer detected by any sensor, the processor may then cause the scrolling of film to continue or resume as prior to the user interrupt.

It is to be appreciated that the scrolling film embodiments may be combined with one or more other embodiments disclosed herein to provide additional protection from sunlight.

It is to be understood that variations and modifications of the present invention may be made without departing from the scope hereof, and that one or more of the different embodiments disclosed herein may be used together with one or more of the other embodiments to provide additional environmental protection for the vending machine. It is also to be understood that the present invention is not to be limited by the specific embodiments or combinations of embodiments, components or parts disclosed herein, nor by any of the exemplary embodiments or combinations set forth in the attached illustrations.

What is claimed is:

1. An apparatus for reducing the amount of sunlight entering the interior of a vending machine through a front panel comprising an obscuring border provided around a central viewing area on said front panel.

2. The apparatus of claim 1 wherein the width of said border is between about 4 and about 12 inches.

3. The apparatus of claim 1 wherein the width of said border is approximately 6 inches.

4. The apparatus of claim 1 wherein advertising is provided on said border.

5. The apparatus of claim 1 wherein said border includes a sunlight inhibiting member selected from the group of: a coating, a mirrored surface, a reflective surface, and combinations thereof.

6. An apparatus for reducing the amount of sunlight entering the interior of a vending machine through a front panel comprising a first obscuring border provided around a central viewing area on said front panel, and a second interior panel behind said front panel, said second panel having a second obscuring border provided around a second central viewing area thereon.

7. The apparatus of claim 6 wherein the width of each of said borders is between about 4 and about 12 inches.

8. The apparatus of claim 6 wherein the width of each of said borders is approximately 6 inches.

9. The apparatus of claim 6 wherein advertising is provided on said first border.

10. The apparatus of claim 6 wherein each of said borders includes a sunlight inhibiting member selected from the group of: a coating, a mirrored surface, a reflective surface, and combinations thereof.

11. An apparatus for reducing the amount of sunlight entering the interior of a vending machine through a front panel comprising a pair of rotatable spools deployed inside said vending machine behind said front panel, at least one motor for operating at least one of said spools, and a film supported on said spools such that said film movably extends across and behind said front panel, said film including at least one obscuring section and at least one separate viewing section for temporary placement behind said front panel.

12. The apparatus of claim 11 wherein an edge of said film has at least one light sensitive property provided in at least one pattern along said edge, a light sensitive device is provided adjacent to said edge for detecting said at least one light sensitive property of said film, and a processor is provided in communication with said device and said at least one motor.

13. The apparatus of claim 12 wherein said pattern includes a different light sensitive property provided at each transition between each section of said film.

14. The apparatus of claim 12 wherein at least one sensor is provided with said vending machine for detecting the presence of a user, said at least one sensor being in communication with said processor.

15. The apparatus of claim 14 wherein said at least one sensor is selected from the group of motion, light, sound, touch, temperature, pressure, and combinations thereof.

16. The apparatus of claim 14 wherein said sensor is operatively associated with one of a coin insert, a keypad, a product selection device, a bill insert, a coin return, a delivery port, and combinations thereof.

17. The apparatus of claim 14 wherein said processor comprises programming for operating said at least one motor in order to temporarily scroll different sections of said film into place behind said front panel for time intervals.

18. The apparatus of claim 17 wherein at least one of said time intervals is of a different length than another of said time intervals.

19. The apparatus of claim 17 wherein said programming is capable of causing said motor to temporarily scroll different sections of said film into place behind said front panel in a manner selected from a sequential order, a random order, and a pre-determined order.

20. The apparatus of claim 14 wherein said processor comprises programming for operating said at least one motor in order to temporarily scroll a particular section of said film into place behind said front panel in response to a signal from said at least one sensor.

21. The apparatus of claim 20 wherein said particular section of film is a viewing section.

22. The apparatus of claim 21 wherein a first obscuring border provided around a central viewing area on said front panel.

23. The apparatus of claim 22 wherein a second obscuring border is provided on at least one of said viewing sections of said film around a second central viewing area thereon.

24. The apparatus of claim 11 wherein all sections of said film include a sunlight inhibiting member selected from the group of: a coating, a mirrored surface, a reflective surface, and combinations thereof.

25. The apparatus of claim 11 wherein lighting is provided behind said film.

26. The apparatus of claim 11 wherein said spools are provided at opposite sides of said front panel.

27. The apparatus of claim 11 wherein said spools are provided at the top and bottom of said front panel.

28. The apparatus of claim 11 wherein at least one guide is provided for said film behind said front panel.

29. The apparatus of claim 11 wherein at least one guide is provided on at least one of said spools.

30. The apparatus of claim 29 wherein said at least one guide is in the form of an annular shoulder.

31. The apparatus of claim 11 wherein at least one sensor is provided in association with said vending machine for detecting the presence of a user, said at least one sensor being in communication with a processor.

32. The device of claim 31 wherein said at least one sensor is selected from the group of motion, light, sound, touch, temperature, pressure, and combinations thereof.

33. The apparatus of claim 31 wherein said sensor is operatively associated with one of a coin insert, a keypad, a product selection device, a bill insert, a coin return, a delivery port, and combinations thereof.

34. The apparatus of claim 31 wherein said processor comprises programming for operating said at least one motor in order to temporarily scroll different sections of said film into place behind said front panel.

35. The apparatus of claim 31 wherein said processor comprises programming for operating said at least one motor in order to temporarily scroll different sections of said film into place behind said front panel for time intervals.

36. The apparatus of claim 35 wherein at least one of said time intervals is of a different length than another of said time intervals.

37. The apparatus of claim 31 wherein said processor comprises programming for operating said at least one motor in order to temporarily scroll a particular section of said film into place behind said front panel in response to a signal from said at least one sensor.

38. The apparatus of claim 37 wherein said particular section of film is a viewing section.

39. The device of claim 31 wherein an encoder is provided adjacent to said film in communication with said processor.

40. In a vending machine having a clear front panel and an interior compartment, an improvement for reducing the amount of sunlight entering the interior through the front panel comprising:
a. a pair of rotatable spools deployed inside said vending machine behind said front panel;
b. at least one motor for operating at least one of said spools;
c. a film supported on said spools such that said film movably extends across and behind said front panel, said film including at least one obscuring section and at least one separate viewing section for temporary placement behind said front panel;
d. at least one sensor for detecting the presence of a user, said at least one sensor being in communication with a processor;
e. programming in said processor for operating said at least one motor in order to temporarily scroll different sections of said film into place behind said front panel for time intervals; and
f. programming in said processor for operating said at least one motor in order to temporarily scroll a particular section of said film into place behind said front panel in response to a signal from said at least one sensor.

41. The vending machine of claim 40 wherein a first obscuring border provided around a central viewing area on said front panel.

42. The vending machine of claim 41 wherein a second obscuring border is provided on said at least one viewing section of said film around a second central viewing area thereon.

43. A method of protecting the inside of a vending machine from sunlight penetrating through a front panel comprising the steps of:
a. temporarily scrolling at least one obscured section of film behind said front panel inside said machine, said at least one obscured section of film reducing the amount of sunlight entering the interior through the front panel;
b. detecting the presence of a user by a sensor;
c. temporarily scrolling an unobscured section of film behind said front panel in response to a signal from the sensor to allow said user to see into said machine;
d. again scrolling at least one obscured section of film behind said front panel inside said machine after the presence of said user is no longer detected.

44. The method of claim 43 wherein the steps of scrolling at least one obscured section of film behind said front panel inside said machine include scrolling a plurality of obscured sections of film in a pattern.

45. The method of claim 43 wherein said pattern is selected from the group of: a sequential order, a random order, and a pre-determined order.

46. A method of protecting the inside of a vending machine from sunlight penetrating through a front panel comprising the steps of:
a. temporarily scrolling at least one obscured section of film behind said front panel inside said machine, said at least one obscured section of film reducing the amount of sunlight entering the interior through the front panel;
b. detecting the presence of a user by a sensor;
c. temporarily scrolling a particular obscured section of film behind said front panel in response to a signal from the sensor;
d. temporarily scrolling an unobscured section of film behind said front panel in response to a second signal from a sensor to allow said user to see into said machine; and
e. again scrolling at least one obscured section of film behind said front panel inside said machine after the presence of said user is no longer detected.
